(19) United States
(12) Patent Application Publication
(10) Pub. No.: US 2012/0005122 A1
(43) Pub. Date: Jan. 5, 2012

(54) REAL ESTATE INVESTMENT METHOD FOR PURCHASING A PLURALITY OF DISTRESSED PROPERTIES FROM A SINGLE INSTITUTION AT FORMULA-DERIVED PRICES

(76) Inventors: Mohammed Salahuddin Khan, Lake Forest, IL (US); Syed Jafer Hasnain, Hinsdale, IL (US)

(21) Appl. No.: 13/235,753

(22) Filed: Sep. 19, 2011

Related U.S. Application Data
(63) Continuation of application No. 12/466,921, filed on May 15, 2009.

(51) Int. Cl. G06Q 40/00

(52) U.S. Cl. 705/36 R

(57) ABSTRACT

A real estate investing method is disclosed in which aggregated investment capital is used to purchase a plurality of properties from a single lending institution at short-sale prices calculated using a pre-negotiated formula. The lending institution agrees to identify and qualify properties, and accept the short-sale prices, in return for selling a plurality of distressed properties under a single agreement. Owners avoid foreclosure and consequent damage to their credit. Investors aren't burdened by property selection and/or maintenance. In preferred embodiments, owner-occupied homes are purchased, leased back to their occupants, and eventually resold to the occupants if their finances recover. Repurchase credit incentives can be offered to occupants, providing limited participation in property appreciation and motivating occupants to maintain the properties and strive to repurchase them. During leases, landlord services are provided under contract by local service providers and/or regional warranty providers. A central support group can provide centralized tenant support.

### RELATED APPLICATIONS

This application claims priority to U.S. patent application Ser. No. 12/466,921 filed May 15, 2009, which is incorporated herein by reference in its entirety.

### FIELD OF THE INVENTION

The invention generally relates to real estate investment methods, and more specifically to methods for investing in distressed real estate.

### BACKGROUND OF THE INVENTION

Historically, real property has proven to be a secure and rewarding investment opportunity. However, real property values can go down as well as up, and therefore investing in real property is not without risk.

Perhaps the most common form of real property investment is the purchase and occupancy of a single-family home. Home ownership provides a unique opportunity to live in and use an investment while it (typically) rises in value. Also, tax benefits are often available to home owners. Typically, a purchaser of a home provides a portion of the purchase price as a “down payment,” and finances the remainder of the purchase price, most commonly by obtaining a mortgage from a lending institution such as a bank.

At any given time, the difference between the balance due on the home financing and the market value of the home is considered to be the owner's “equity” in the home. If a financial need arises for any reason, a home owner can often draw upon this equity by various means, such as by home refinancing or by obtaining a home equity loan. Other methods of tapping equity have also been proposed, such as the sale of a partial interest in the home or dividing of the home equity into “shares” that are sold to investors.

However, if the financial situation of a home owner declines, and if at the same time a market downturn causes the market value of the home to drop, a homeowner can sometimes face a situation wherein he or she is unable to meet the payment requirements of the mortgage or other home financing, and at the same time has little or no home equity to draw upon. It may even happen that the equity of the home owner becomes at least temporarily negative, wherein the financed amount exceeds the current, depressed value of the home.

When a home owner is unable to meet his or her home financing payment requirements, the home is referred to as a “distressed” property. In such cases, the bank or other lending institution faces a dilemma. It can simply wait and hope that the home owner's fortunes improve, it can renegotiate the loan at more favorable terms to the home owner, or it can take ownership of the property from the owner through foreclosure, and then attempt to sell the property to recover as much as possible of the financed amount.

Each of these possible actions includes major disadvantages. If the lending institution simply waits, there is no guarantee that the situation will improve. If the lending institution negotiates a new agreement that is more favorable to the home owner, this essentially rewards the home owner for being delinquent, and may encourage other borrowers to default as well so as to seek better terms.

On the other hand, if the lending institution forecloses, the bank or other lending institution will be forced to carry the home as an asset on their books while trying to arrange for its sale. Since lending institutions are typically not in the real estate business, repairing, renting, leasing, and/or otherwise maintaining real property and preparing it for resale is a significant burden on the lending institution.

Also, in many countries a bank is required by law to maintain its assets to be no less than a certain fraction of all loans on its books. A foreclosure or non-performing loan forces the bank to mark down the asset value of the bad loan and can force the bank into raising new capital to maintain its standing, for example with the FDIC in the US. Therefore, the bank will typically seek to divest itself of foreclosed real property as quickly as possible so as to obtain cash against which new lending can take place. The result will often be a sale of the property by the lending institution at a price significantly below the fair market value, and at a time when the market remains low and the property is worth less than it can be expected to be worth under more typical market conditions. Moreover, the foreclosure process itself is expensive and time consuming, and once a bank takes ownership of a property it must bear the additional costs of maintaining the now vacated property, the cost of paying tax obligations on the property, the cost-of-capital tied up in the property, and the cost of engaging realtors and/or auctioneers for the deeply discounted sale of the property into what may be a temporarily depressed real estate market.

Foreclosure also includes significant disadvantages for the home owner. If the bank forecloses, the now-previous home owner (who is referred to for simplicity throughout this document as the “original” home owner, although there may, in fact have been preceding owners) will be forced to move out of the home, find another home, and expend his or her remaining financial resources in making rent or lease payments to some other entity. Also, the ability of the original owner to obtain credit in the future will be severely compromised.

The conditions that lead to property becoming distressed are usually short-term, since it can be expected that the value of a home will rise in the long term, and it can often be expected that the financial situation of a home owner will eventually improve, for example as the economy improves, or as the home owner retrains and/or finds new employment. Nevertheless, when a property becomes distressed, both the home owner and the lending institution typically have great difficulty finding ways to deal with the situation, even on a short-term basis.

For all of the above reasons, the short-sale purchase and eventual resale of distressed homes has long been recognized as a significant investment opportunity, wherein the investor benefits from the eventual rise in value of the home and the lending institution is relieved of the time-consuming burden of prosecuting a foreclosure and/or of finding a buyer for the property. If foreclosure is not yet complete, the home owner also benefits by avoiding future credit problems that would result from a foreclosure.

However, investing in distressed properties requires significant amounts of investment capital, which may not be available to many investors. And even if sufficient capital is available, an investor may be limited to investing in only one, or in a very small number of properties, thereby increasing the risk. Also, careful selection must be made of the property, or properties, to be purchased, which requires a costly investment of time, study, and expertise. In addition, each purchased property must be maintained and managed as it is prepared for re-sale. If the property is to be held pending an improvement in the real estate market, then an investor might typically seek to rent the property. However, this requires that renters or tenants be located and carefully screened, and the rental or lease of the property must be managed. Once again, this requires a costly investment of time and management expertise.

Approaches have been suggested that would aggregate investor funds so as to provide sufficient capital to purchase a plurality of distressed properties, thereby reducing the minimum amount required from each investor and reducing the overall risk. However, these approaches typically do not address the other problems discussed above, and they introduce new problems of their own.

While a short-sale acquisition can be attractive to an investor, or a group of aggregated investors, the traditional pre-foreclosure short-sale model requires that the initiative be taken by the homeowner in distress, or at least by the homeowner and would-be investor together. This will typically prevent a speedy implementation of the investment solution, since a lending institution will typically take time to satisfy itself that the proposed transaction is at an acceptable price. Moreover, a lending institution will also be potentially concerned about the appearance of impropriety in accepting a proposal from one party on arguably more favorable terms than from another party. This will cause the lending institution to evaluate each proposal in significant depth, and will prolong the time during which the property remains in distress.

### SUMMARY OF THE INVENTION

A method of real estate investing is claimed that aggregates investment capital, removes the burden of property selection from investors, provides lenders with a formulaic and objective pricing mechanism which pre-approves acceptable pricing from the lender's viewpoint, provides uninterrupted lease income while time is allowed for the property to appreciate in value, eliminates the burden of tenant selection and screening, provides for cost-efficient real estate management, and provides a pre-selected, pre-qualified, and motivated buyer for the eventual re-sale of the property.

According to the present invention, an investment group is formed that aggregates investment funds from a plurality of investors so as to accumulate sufficient funds to purchase a plurality of distressed properties. An offer is then made by the investment group to at least one bank or other lending or financing institution (herein referred to generically as the “bank”), whereby the investment group offers to execute short-sale purchases of a plurality, and preferably of all, of the distressed homes financed by the bank that qualify according to specified formulaic criteria. In preferred embodiments, the formulaic criteria can be readily applied by the bank to information that is already at hand and/or publicly available and easily obtained.

The agreement also includes a formula that can be readily applied by the bank to determine the short-sale purchase prices that the bank would need to accept in settlement of borrowers' outstanding obligations. This approach places the burden of candidate property evaluation and selection onto the bank, rather than the investment group, in return for an offer to relieve from the bank the burden of a plurality of distressed properties with a single negotiated agreement.

Once the bank has identified a group of candidate properties, the investment group purchases a plurality of the properties from their respective owners. In various preferred embodiments, the negotiated agreement can be independent of the occupancy status of a property, or it can be limited to homes still occupied by their pre-foreclosure owners. Similarly, the agreement can be independent of ownership status, or limited to properties that have not yet completed the foreclosure process, and are therefore not-yet bank owned.

In preferred embodiments that are limited to owner-occupied properties, the owner-occupant is first approached by the bank with information about the purchasing program. If the owner-occupant is interested in the purchasing program, and is willing to accept the formulaically determined purchase price, the owner-occupant then contacts the investment group directly and asks to be included in the program. If the owner-occupant's credit is sufficient to meet the requirements of a qualified lease-back agreement, a purchase offer is then made by the investment group directly to the owner-occupant, whereby the home will be purchased by the investment group and then leased back to the owner-occupant.

This approach allows the owner-occupant, also referred to herein as the “original owner,” to avoid foreclosure, while remaining in his or her home and preferably paying a lease amount that is not substantially more than what the original owner would have otherwise paid if forced to move and find a new home, Typically, the lease amount is also significantly lower than the original owner's monthly mortgage payment obligation immediately preceding the purchase, since the formulaically determined sales price to the investment group is typically much lower than the original sales price upon which the previous mortgage amount was based. Moreover, in preferred embodiments, the outstanding mortgage balance will exceed the appraised value of the property. In such cases, the formulaically determined sales price to the investor group will be significantly lower than the outstanding mortgage balance.

In preferred embodiments, an offer to purchase an owner-occupied home includes a guaranteed period of time during which the original owner will have at least a right of first refusal to repurchase the home, subject to sufficient and verifiable improvement in the owner's credit qualification or finances. In some preferred embodiments, the offer guarantees that the home will not be sold to anyone other than the original owner for a specified period of time, such as five years. In still further preferred embodiments, the original owner can be enticed to diligently maintain the property in good order through an earned repurchase discount to be applied as a percentage reduction to the appraised value of the property at the time of repurchase by the original owner; the earned repurchase discount being earned on a basis which causes the discount to increase with time subject to sustained desirable behavior by the tenant, such as proper upkeep of the property and prompt payment of lease payments, while being independent of the actual amount of lease payments made.

In preferred embodiments, the method further includes providing of real estate management services for the purchased and leased properties. In some of these embodiments, the management is contracted out to existing management organizations, while in other embodiments a separate management organization is created.

In certain embodiments, the claimed method includes the establishment of a support website and a central support call center as well as regional support offices and support agreements with local contractors for providing major repairs, while a warranty organization deals with minor repairs. In some of these preferred embodiments, the local contractor is held on retainer for a fixed monthly fee, and is required to perform regular inspections of the property as well as respond to major repair callout requests at hourly rates that are reduced in view of the retainer. In similar preferred embodiments, a warranty organization is paid a regular fixed fee with the understanding that callout requests will incur a low hourly charge. It is an object of the invention in such embodiments that even in cases where at least a portion of the hourly charge is born by the occupant, the occupant is nevertheless motivated by the low hourly charges to make calls promptly to the call center, so as to ensure a rapid response to repair issues and thereby minimize any additional damage or deterioration to the property or fixtures and fittings therein.

One general aspect of the present invention is a method for investing in distressed real estate properties. The method includes aggregating monetary investments from a plurality of investors so as to accumulate investment capital, and negotiating an agreement with a lending institution to purchase a plurality of distressed real estate properties at purchase prices to be calculated using a pricing formula specified in the agreement. The agreement further requires the lending institution to identify a plurality of qualifying distressed properties by applying property qualifying criteria specified in the agreement to properties that are currently financed by the lending institution, and the agreement requires the lending institution to release all claims pertaining to each qualifying distressed property that is purchased under the agreement, in return for receipt by the lending institution of a specified portion of the purchase price.

The method further includes using the investment capital to purchase at least some of the qualifying distressed properties at the calculated purchase prices, re-selling each of the plurality of purchased properties so as to produce proceeds, and distributing at least some of the proceeds among the plurality of investors.

In preferred embodiments, the agreement includes an offer to purchase all candidate properties identified by the lending institution, until a specified maximum aggregated purchase price is reached.

In some preferred embodiments, the pricing formula used to calculate the purchase price “P” for a distressed property having an appraised value “A” and a financing “mortgage” balance “M” can be expressed as:

P=MF×Min(J×A,K×M);

where MF is a “market factor” that depends on real estate factors applicable to a region in which the property is located;

“Min” indicates that MF is multiplied times the smaller of J times A and K times M;

J is a number between zero and one, inclusive;

K is a number between zero and one, inclusive; and

K is less than J if M is greater than A.

In some of these embodiments J is 0.7 and K is 0.65. In other of these embodiments the real estate factors upon which MF depends include a density of foreclosures DF and a rental cap rate CR,

the density of foreclosures DF being expressible as a ratio of all properties that are located within a specified region to all properties that are in foreclosure in the specified region; and

the rental cap rate CR being expressible as a ratio of average annual gross rental income to average property value for all rental properties in the specified region.

In some of these embodiments the real estate factors upon which MF depends further include at least one of:

a population density “DP” that indicates an average density of residents in the specified region, DP being expressible as residents-per-unit area;

an average household size “H” that indicates an average number of residents residing in each household in the specified region, H being expressible as a number of residents;

a number of foreclosures per unit area “FD” that indicates a number of properties in foreclosure per unit area within the specified region, FD being calculated according to the formula FD=DP/(H×DF); and

an average separation of foreclosures “SF” that is calculated according to the formula SF=0.5/(SQRT(FD)), where “SQRT(FD)” is the square root of FD.

And in some of these embodiments the market factor can be calculated according to the formula MF=(0.9+CR)×(1-0.09 exp(−2.2×SF)), where exp is the exponential function.

In preferred embodiments the property qualifying criteria applied to properties by the lending institution include a negative equity requirement that an estimated value of the property be below its financing balance, and/or an unencumberment requirement that there be no tax liens and no contractor liens applicable to the owner-occupied property.

In some of these embodiments the estimated value of the owner-occupied property is determined by multiplying a published value-per-square-foot parameter associated with a region in which the property is located and a total square-footage of the property.

In various preferred embodiments the agreement further requires that the lending institution offer to any holder of a secondary lien on a qualifying distressed property a financial inducement, in return for the secondary lien holder withholding any objections it may have to a suspension of foreclosure of the qualifying distressed property. And in some of these embodiments the financial inducement is the lesser of a specified dollar amount and a specified percentage of an outstanding balance of the secondary lien owed to the holder of the secondary lien.

Certain preferred embodiments further include leasing at least some of the plurality of purchased properties to tenants before selling the properties, and providing landlord services to the tenants during the leasing, including maintenance, repairs, and collection of lease payments. Some of these embodiments further include distributing to the investors at least a portion of lease payments received from tenants occupying the purchased properties. In other of these embodiments at least some of the landlord services are subcontracted to at least one of local service providers and regional warranty providers. In still other of these embodiments at least some of the landlord services are coordinated by a central landlord services group. And yet other of these embodiments further include creating a central support group that can provide support services to the tenants.

Another general embodiment of the present invention is a method for investing in distressed single-family properties. The method includes aggregating monetary investments from a plurality of investors so as to accumulate investment capital and negotiating an agreement with a lending institution to purchase a plurality of distressed single-family properties at purchase prices to be calculated using a pricing formula specified in the agreement.

The agreement further includes requiring the lending institution to identify a plurality of qualifying single-family properties by applying property qualifying criteria specified in the agreement to single-family properties that are financed by the lending institution and currently occupied by owner-occupants, and the agreement includes requiring the lending institution to release all claims pertaining to each qualifying property that is purchased under the agreement, in return for receipt by the lending institution of a specified portion of the purchase price.

The method further includes, for each qualifying property, applying occupant qualifying criteria to the owner-occupant, so as to determine if the owner-occupant is a qualified occupant who is financially qualified to be a tenant of the property, using the investment capital, purchasing at the calculated purchase prices at least some of the plurality of qualifying distressed properties that are occupied by qualified occupants, leasing each purchased property to its qualified occupant, re-selling each of the plurality of purchased properties so as to produce proceeds, each purchased property being re-sold, if possible, to its qualified occupant, and distributing at least some of the proceeds among the plurality of investors.

In preferred embodiments, the occupant qualifying criteria applied to each owner-occupant include at least one of:

a non-delinquency requirement that there have been no over-60-days finance payment delinquencies during two years prior to a most recent finance rate adjustment;

a non-delinquency requirement that there have not been more than two over-30-days finance payment delinquencies during two years prior to a most recent finance rate adjustment;

if the owner-occupant is employed by an employer, an employment verification requirement verifying the employment and gross income of the owner-occupant;

if the owner-occupant is self-employed, a three year balance sheet requirement verifying the ability of the owner-occupant to produce a sustained income;

a job security requirement verifying that an acceptable degree of job security applies to at least one of an occupation and an industry of employment of the owner-occupant;

a job security requirement verifying that an acceptable published job security score applies to at least one of an occupation and an industry of employment of the owner-occupant;

a requirement that applicable lease payments for the property will not exceed a specified percentage of the owner-occupant's gross income;

a requirement that a total of applicable lease payments and other recurring payment commitments of the owner-occupant will not exceed a specified percentage of the owner-occupant's gross income;

a requirement that there are no unsatisfied court judgments applicable to the owner-occupant;

a requirement that there are no pending civil or criminal court proceedings applicable to the owner-occupant; and

a requirement that there have been no prior un-discharged bankruptcies applicable to the owner-occupant during seven years prior to a proposed date of purchase.

In some preferred embodiments the occupant qualifying criteria applied to each owner-occupant include a requirement that applicable lease payments for the property will not exceed 25% of the owner-occupant's gross income. In other preferred embodiments the occupant qualifying criteria applied to each owner-occupant include a requirement that a total of applicable lease payments and other recurring payment commitments of the owner-occupant will not exceed 34% of the owner-occupant's gross income.

In certain preferred embodiments, re-selling the plurality of purchased properties includes, for each purchased property, before accepting an offer from a third party to purchase the property, providing an opportunity to the qualified occupant to match the offer and thereby purchase the property.

In various preferred embodiments re-selling the plurality of purchased properties includes, for each purchased property, not reselling the purchased property for a specified period of time to any buyer other than the qualified occupant. And in some of these embodiments the specified period of time is at least five years.

In preferred embodiments, re-selling the plurality of purchased properties includes offering to re-sell each purchased property to its qualified occupant at a resale price that is not higher than an appraised price, the appraised price being determined by at least one independent appraiser. And in some of these embodiments the resale price is calculated by applying a repurchase discount percentage reduction to the appraised price, the repurchase discount percentage reduction being calculated on a basis which causes it to increase with time subject to sustained desirable behavior by the qualified occupant.

### BRIEF DESCRIPTION OF THE DRAWINGS

The invention will be more fully understood by reference to the detailed description, in conjunction with the following figures, wherein:

FIG. 1A is a flow diagram illustrating an embodiment of the present invention that is applicable to investment in distressed properties of any type, with any ownership, and with any occupancy;

FIG. 1B is a flow diagram illustrating an embodiment of the present invention that is applicable only to distressed owner-occupied single-family homes, and includes leasing back of the properties to their occupants;

FIG. 2 is a flow diagram that presents an expanded illustration of the property qualifying steps of the method of FIG. 1B; and

FIG. 3 is an organizational diagram illustrating an organizational structure used in a preferred embodiment to provide support services to tenants of purchased properties.

### DETAILED DESCRIPTION OF PREFERRED EMBODIMENTS

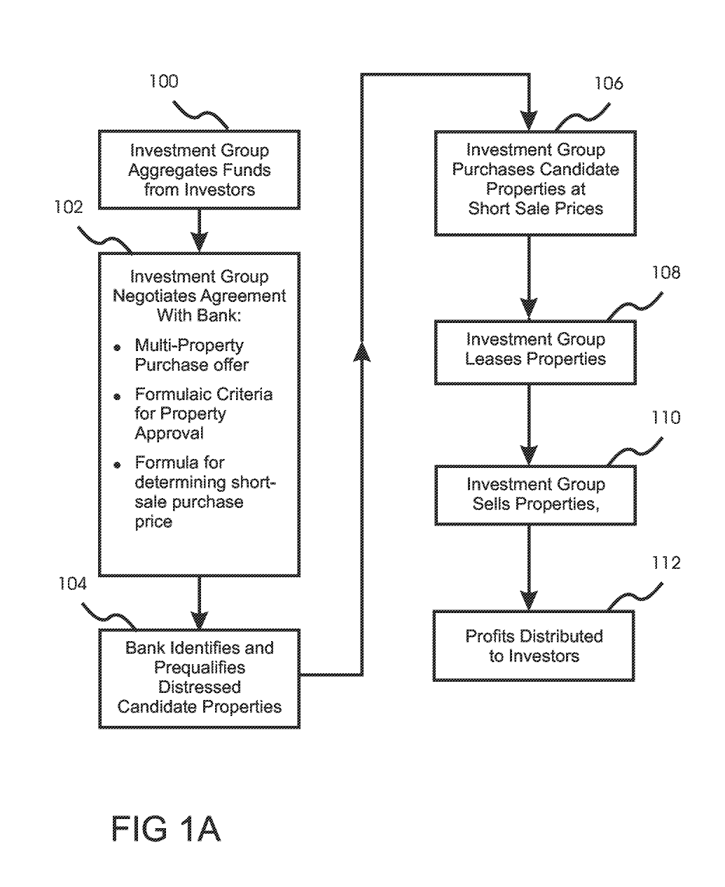

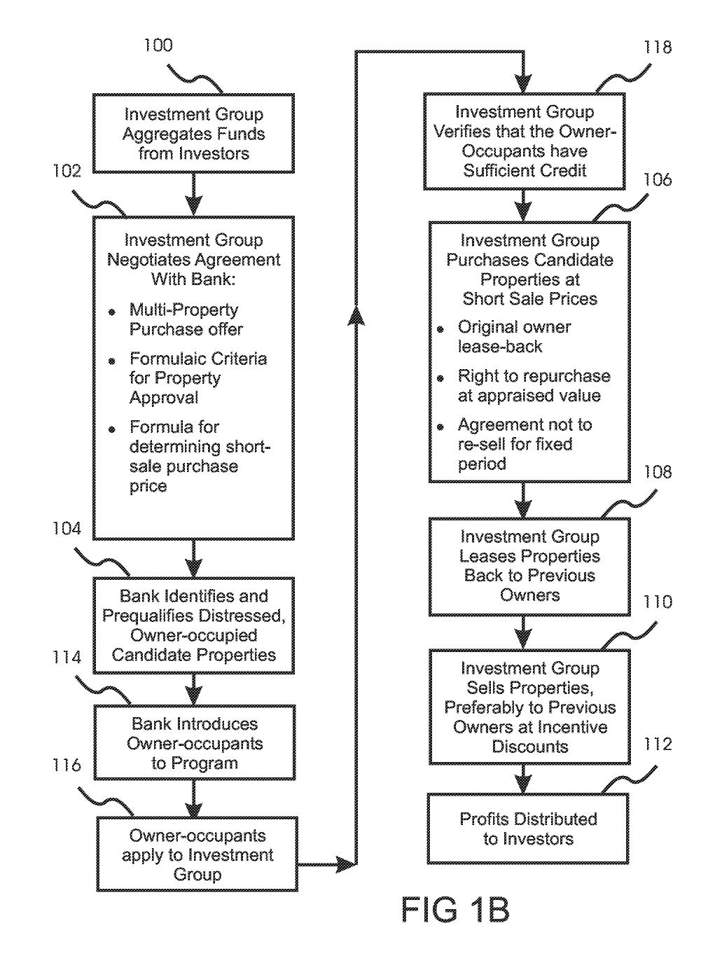

With reference to FIG. 1A, one embodiment of the present invention is a method for investing in distressed real estate that does not depend on the ownership status of the real estate. For example, in this embodiment the distressed real estate can be a property in danger of foreclosure but still owned by an owner-occupant, it can be a property in danger of foreclosure but still owned by an owner who does not occupy the property, or it can be a property that has already been foreclosed and is currently owned by the bank. In this embodiment, the property can be a single-family home, a multi-family dwelling, or a commercial property.

So as to reduce risk by purchasing a plurality of properties, while at the same time reducing the amount of investment required from each investor, funds are aggregated from a plurality of investors 100. The resulting pool of investment funds is then used for investment in distressed properties, which can be direct investment, or if more tax efficient, indirect investment. The pool of investment funds is also used to pay for overhead services required by the method, some of which are described below. The entity that holds and manages these funds is referred to in FIG. 1A as an “investment group,” but it can take on any suitable form known in the art, such as a limited partnership, an LLC, or any other suitable corporate form, and it can be organized and registered in any country according to tax and other criteria, regardless of where investment properties are to be purchased.

A key step in the present method is the negotiation of an agreement 102 with at least one bank or other financing institution to purchase a plurality of distressed properties. For simplicity, the term “bank” is used herein to refer to any lending or financing institution that provides mortgages and/or other financing for the purpose of purchasing property, and the term “mortgage” is used herein to refer to any such financing applied to real property.

As discussed above, properties become distressed when the owner is at least temporarily unable to meet his or her financing payment obligations. If the situation is not rectified, such properties will typically progress from “pre-foreclosure” (owner has been notified that foreclosure is imminent), to “foreclosure” (formal foreclosure procedures are in process), and finally to “post-foreclosure” (property is owned by the bank).

Distressed properties are a major liability for banks and other financing institutions. The process of foreclosure is expensive and time consuming, and once a foreclosure is completed a bank must find a way to dispose of the property as quickly as possible. It is therefore common for a bank to sell post-foreclosure properties at auction, and/or to accept settlement of the debt at “short sale” prices below the prevailing debt balance, and sometimes even below the fair market price.

The negotiated agreement 102 of the present invention is attractive to banks and other financing institutions because it presents an opportunity for a bank to facilitate the sale of a plurality of distressed properties to a single purchaser, i.e. the investment group, through enactment and implementation of a single agreement. In preferred embodiments, the agreement can offer to purchase all distressed properties that meet certain requirements, at least up to a total aggregate purchase price. Depending on the embodiment, the agreement can be applicable to distressed properties at all stages, including post-foreclosure properties owned by the bank, or it can be limited to properties that are not yet bank owned. The agreement can also be applicable to properties with any occupancy status, or limited to properties that are owner-occupied. In addition, the agreement can be limited to any combination of property types, such as single family homes, multi-family homes, and/or commercial properties.

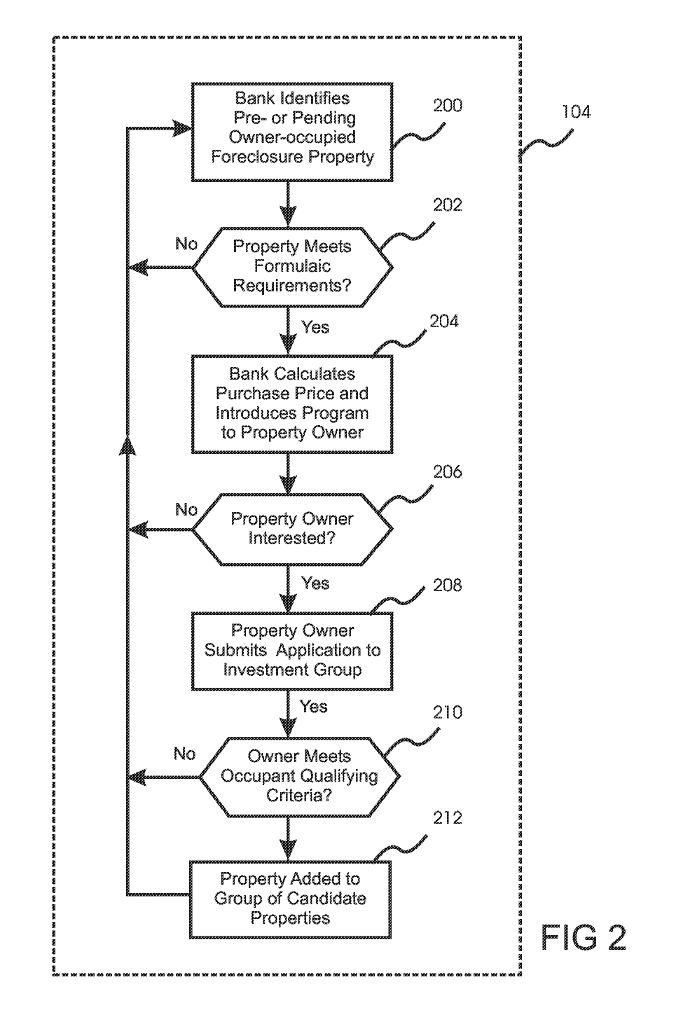

In return for being relieved of the burden of a plurality of distressed properties, the negotiated agreement places significant responsibilities onto the bank that would otherwise be placed on the investment group. In particular, the bank is required to apply formulaic criteria to distressed properties so as to identify candidates for purchase by the investment group. The agreement also includes at least one formula to be used by the bank for determination of short-sale purchase prices that must be accepted by the bank in settlement of all outstanding borrower debts. The steps required of the bank by the negotiated agreement 102 in an embodiment that is limited to owner-occupied homes are discussed in more detail in reference to FIG. 2 below.

Once the bank has identified and pre-qualified a group of distressed, candidate properties 104, the investment group purchases some or all of the candidates 106 at the short-sale prices calculated using the pricing formula included in the agreement. The properties can then either be sold immediately 110, or leased 108 to tenants according to lease agreements established by the investment group. Leasing 108 provides an income stream if it is desirable to allow time for a temporarily depressed real estate market to recover.

Eventually, the investment group sells the purchased properties 110 at a substantially fair market price, and the profits from the re-sale of the properties are distributed among the investors 112. In preferred embodiments, a portion (typically the net operating income portion) of the collected lease payments is also distributed among the investors.

FIG. 1B illustrates a preferred embodiment that is similar to FIG. 1A, except that it is limited to investing in properties that are owner-occupied. In this embodiment, after the investment group purchases the properties they are leased back to the occupants 108 and, if possible, the properties are eventually re-sold to the occupants 110.

According to this embodiment, after pre-qualifying a distressed property 104, the bank introduces the owner-occupant to the purchasing program 114 and explains the bank's willingness to accept the calculated sales price. If the owner-occupant is interested in the program and willing to accept the calculated sales price as full settlement for the property debt, the owner-occupant submits an application 116 to the investment group to be included in the program. The investment group verifies 118 the credit of the owner-occupant, and if the owner-occupant has sufficient credit to qualify for a lease, the investment group adds the property to the list of candidate properties.

The investment group then directly contacts candidate owners and offers to purchase their properties 106. As part of the purchase agreements, the previous owner-occupants (who are referred to for simplicity throughout this document as the “original owners”, although there may, in fact have been preceding owners) agree to lease the properties 108 according to lease agreements established by the investment group, and to remain as tenant occupants. This provides uninterrupted lease income to the investment group and eliminates the burden of locating and qualifying new tenants, while at the same time allowing the occupants to remain in their homes at lease payment rates that are more affordable than the previous financing payments.

In the embodiment of FIG. 1B, when the properties are eventually sold, they are preferably sold to the original owners 110, who have continued to occupy the properties since they were purchased by the investment group 106. In some preferred embodiments, the investment group agrees not to re-sell the property for a specified amount of time. Typically, this is a minimum period of time, such as five years, which allows the property to recover in market value, and also allows time for the occupant to recover financially from whatever difficulty caused the property to become distressed in the first place.

In some preferred embodiments, the investment group also agrees to offer a right of first refusal to the original owner before accepting any offer to re-sell the property, whereby if the original owner's credit and/or overall financial situation has improved sufficiently, the original owner will have the right to match the offer and repurchase the property. In other preferred embodiments, if the original owner's credit and/or overall financial situation has improved sufficiently, the investment group agrees to offer to sell the property back to the original owner at a certain future time at a price to be determined by at least one, and preferably by two, independent appraisers.

In yet a further preferred embodiment, if the original owner's credit and/or overall financial situation has improved sufficiently, the investment group agrees to offer to sell the property back to the original owner at a time of the original owner's choosing, and at a purchase price to be based on an appraised value determined by at least one, and preferably two, independent appraisers, the purchase price to be no more than the appraised value, and preferably to be reduced below the appraised value by an earned repurchase discount whose magnitude is expressed as a discount percentage of the average appraised value, the discount percentage increasing with time according to a predefined schedule and according to other predefined conditions pertaining to the tenancy and to the level of capital appreciation over the investment group's acquisition cost basis in the property. This discount percentage approach provides an additional incentive to the original owner to repurchase the property, by providing a tax-free opportunity for the original owner to participate in a limited fashion in the value appreciation of the property during the leasing period.

FIG. 2 is a flow diagram that illustrates in greater detail the steps required in identifying qualified candidate properties under the negotiated agreement 102 of the embodiment of FIG. 1B. The bank begins by identifying a distressed property that is currently financed by the bank 200. Typically, this is a pre-foreclosure or a pending foreclosure property. The bank then applies to the property 202 one or more formulaic property requirements specified in the negotiated agreement 102. In preferred embodiments, application of the formulaic property requirements only requires information that is already known to the bank due to the existing property financing, such as the outstanding financing balance, and/or information that is generally available, such as local foreclosure rates and local real estate price trends and sales data.

In preferred embodiments, the formulaic property requirements include a negative equity requirement that an estimated value of the owner-occupied property be below its financing balance, a non-delinquency requirement that there must have been no over-60-days finance payment delinquencies during a specified period such as two years prior to a most recent finance rate adjustment, a non-delinquency requirement that there must not have been more than two over-30-days finance payment delinquencies during two years prior to a most recent finance rate adjustment, and/or an unencumbered requirement that there be no tax liens and no contractor liens applicable to the owner-occupied property. And in some preferred embodiments, the estimated value of the owner-occupied property is determined by multiplying a published value-per-unit-area applicable to the region in which the property is located by the total area included in the property.

In some preferred embodiments that include a negative equity requirement, a small token payment is offered to any separate holder of a second mortgage, or to any other secondary lien holder. The token payment is in settlement of any amounts owed to the secondary lien holder by the borrower, and is typically more attractive than the zero amount that a secondary lien holder would expect to receive from a completed foreclosure of a negative equity property. The object of this feature of the invention is to induce secondary lien holders not to object to any suspension of foreclosure proceedings while the bank holding the primary mortgage permits a short sale on terms that it finds acceptable.

If the property meets the formulaic property requirements, the bank then calculates a proposed purchase price using the pricing formula included in the negotiated agreement 102, and introduces the purchase program to the owner-occupant 204, including the proposed purchase price.

In preferred embodiments, the pricing formula used to calculate the purchase price “P” for a distressed property having an appraised value “A” and a financing “mortgage” balance “M” can be expressed as:

P=MF×Min(J×A,K×M); Eqn 1

Where

0<J<1.0, Eqn 2

0<K<1.0, Eqn 3

and typically, J>K for any negative equity home. MF is a “market factor” that depends on real estate market conditions applicable to a region in which the property is located, and “Min” indicates selection of the lesser of the two terms in parentheses immediately following it. In preferred embodiments, the value of MF increases with increasing rental rates, and decreases with increasing foreclosure density. In some preferred embodiments, J is 0.7 and K is 0.65.

In some of these preferred embodiments, the market factor MF depends on one or more of:

a foreclosure density “DF” that can be expressed without units as a ratio of households to foreclosure households;

a population density “DP” that can be expressed in units of residents-per-unit area;

an average household size “H” that can be expressed in units of residents; and

a number of foreclosures per unit area “FD” that can be expressed in units of inverse area.

In some of these embodiments, the number of foreclosures per unit area “FD,” calculated according to the formula

FD=DP/(H×DF); Eqn. 4

and an average separation of foreclosures “SF” can be calculated according to the formula

SF=0.5/(SQRT(FD)), Eqn. 5

where “SQRT” indicates that the square root of FD is calculated.

In certain of these embodiments, the market factor can then be calculated according to the formula

MF=(0.9+CR)×(1−0.09exp(−2.2×SF)), Eqn 6.

where exp is the exponential function, and CR is a local rental cap rate expressed as the sum of a year's aggregate rental payments divided by the market value, for properties in the region of interest, which in the United States could be the area included in a ZIP code or county

If the owner-occupant expresses interest in selling his or her property under the program 206, the owner-occupant submits an application 208 to the investment group asking to be included in the purchase program.

When the investment group receives the application 208, it applies a set of occupant qualifying criteria to the owner-occupant, so as to determine if the owner-occupant is qualified to lease the property and continue occupancy if the property is purchased by the investment group. In preferred embodiments, the occupant qualifying criteria include:

an employment verification requirement verifying the employment and gross income of an employed owner-occupant of the property;

a three year balance sheet requirement verifying the ability of a self-employed owner-occupant to produce a sustained income;

a job security requirement verifying that an acceptable degree of job security applies to the occupation and/or industry of employment of the owner-occupant, where in preferred embodiments a published job security score is used to determine the degree of job security (for example, a requirement that an individual job security score published by ScoreLogix LLC, and available at www.scorelogix.com, be at least 650 on a scale of 350 to 900);

a requirement that applicable lease payments for the property will not exceed a certain percentage of the owner-occupant's gross income, which in preferred embodiments is 25%;

a requirement that a total of applicable lease payments and other recurring payment commitments of the owner-occupant will not exceed a certain percentage of the owner-occupant's gross income, which preferably greater than the lease payment percentage, and more preferably 34%;

a requirement that there are no unsatisfied court judgments applicable to the owner-occupant;

a requirement that there are no pending civil or criminal court proceedings applicable to the owner-occupant; and/or

a requirement that there have been no prior un-discharged bankruptcies applicable to the owner-occupant during seven years prior to a proposed date of purchase.

The steps illustrated in FIG. 2 are then repeated for a plurality of distressed properties currently financed by the bank or other financing institution. In preferred embodiments, all such properties are evaluated by the bank according to the steps of FIG. 2. In some preferred embodiments, a plurality of banks or other financing institutions implement the steps of FIG. 2, according to agreements 102 negotiated with each such financing institution.

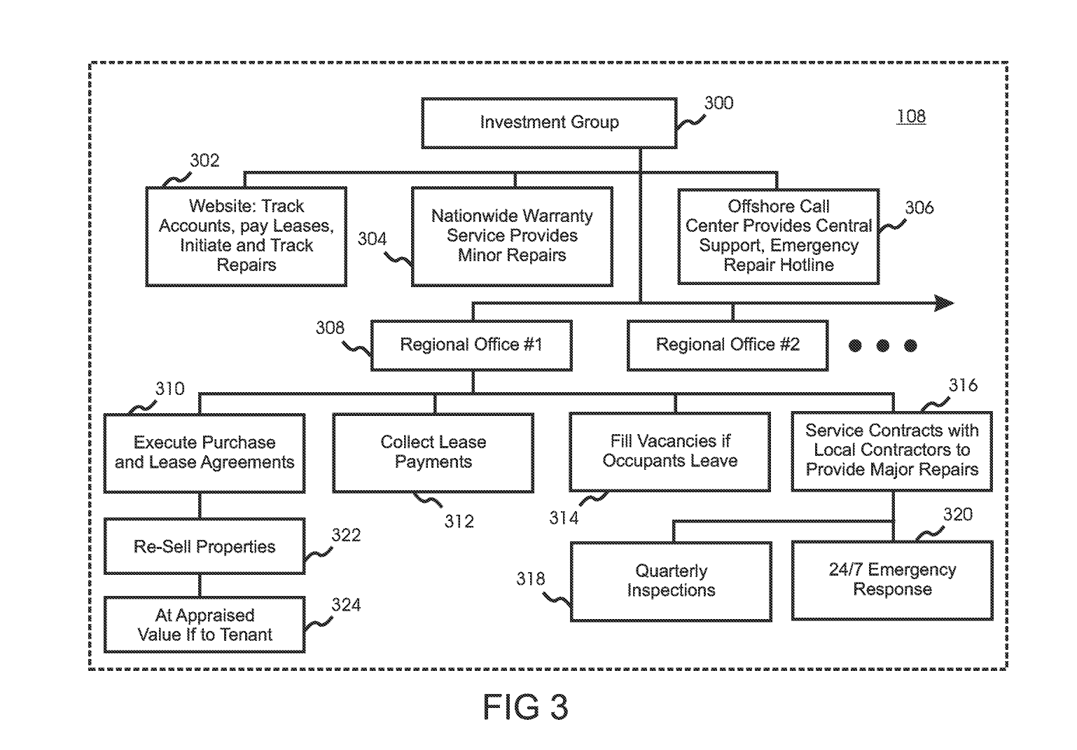

FIG. 3 is an organization chart that illustrates an organizational approach used in a preferred embodiment to provide support services to tenants of the purchased properties during the leasing period 108. In this preferred embodiment, the investment group 300, or a designated partner thereof, establishes a website 302 that allows tenants to track their accounts, make lease payments, and/or initiate and track service and repair calls. Minor repairs 302 are provided to all tenants of the investment group 300 under a warranty purchased from a nationwide warranty service provider. The nationwide minor repair warranty 302 provides for a fixed, predictable cost which reduces the hourly charge for all minor repairs, the cost being negotiated at a low rate due to the coverage of a plurality of properties. Use of a nationwide service provider also provides for service at all lease property locations without requiring the investment group 300 to identify and coordinate the activities of local personnel for this purpose.

In addition, the investment group 300 establishes a central call center 306 that provides centralized support, including an emergency repair hotline, to all of the tenants. In preferred embodiments, the central call center 306 is located offshore, so as to reduce costs.

So as to provide for local services, in the preferred embodiment of FIG. 3 regional offices are established 308 that serve each region where distressed properties are purchased and managed. The regional offices 308 oversee the execution of the purchase and lease agreements 310, and collect the lease payments from the tenants 312. If vacancies occur 314, the regional offices take responsibility for locating and qualifying new tenants, and for executing new lease agreements to fill the vacancies 314. This can be done either directly, or with the help of local real estate and other lease management organizations.

The regional offices 308 also negotiate service contracts 316 with local contractors so as to provide for major repairs as needed. In preferred embodiments, the major repair service contracts provide for periodic inspections of the leased properties, preferably on a quarterly basis 318, and for 24 hour-per-day, seven days-per-week emergency repair services 320. Another preferred embodiment provides for the service contractors to be paid a retainer with fixed periodic payments derived from rental income, the amount of the retainer being set so as to cause the event callout hourly rate to be suitably reduced, thereby creating an incentive for tenants not to delay in calling for help with major issues.

When the lease periods 108 are over, the regional offices 308 arrange for the resale 322 of the properties, preferably to the original owners who have remained as tenants. In such cases, the regional offices arrange for at least one, and preferably two independent appraisers to appraise each property, so that the property can be offered for sale to the original owner at a price that is either equal to the appraised value 324, or preferably reduced below the appraised value by a discount according to terms specified in the lease agreement. In some preferred embodiments the discount increases with time, subject to timely payment of lease payments and to certain desirable behaviors by the tenant in his or her upkeep of the property.

Other modifications and implementations will occur to those skilled in the art without departing from the spirit and the scope of the invention as claimed. Accordingly, the above description is not intended to limit the invention except as indicated in the following claims.

What is claimed is:

1. A method for investing in distressed single-family properties, the method comprising:
aggregating monetary investments from a plurality of investors so as to accumulate investment capital;
negotiating an agreement with a lending institution to purchase a plurality of distressed single-family properties at purchase prices to be calculated using a pricing formula specified in the agreement,
the agreement requiring the lending institution to identify a plurality of qualifying single-family properties by applying property qualifying criteria specified in the agreement to single-family properties that are financed by the lending institution and currently occupied by owner-occupants, and
the agreement requiring the lending institution to release all claims pertaining to each qualifying property that is purchased under the agreement, in return for receipt by the lending institution of a specified portion of the purchase price;
for each qualifying property, applying occupant qualifying criteria to the owner-occupant, so as to determine if the owner-occupant is a qualified occupant who is financially qualified to be a tenant of the property;
using the investment capital, purchasing at the calculated purchase prices at least some of the plurality of qualifying distressed properties that are occupied by qualified occupants;
leasing each purchased property to its qualified occupant;
re-selling each of the plurality of purchased properties so as to produce proceeds, each purchased property being re-sold, if possible, to its qualified occupant; and
distributing at least some of the proceeds among the plurality of investors.

2. The method of claim 1, wherein the occupant qualifying criteria applied to each owner-occupant include at least one of:
a non-delinquency requirement that there have been no over-60-days finance payment delinquencies during two years prior to a most recent finance rate adjustment;
a non-delinquency requirement that there have not been more than two over-30-days finance payment delinquencies during two years prior to a most recent finance rate adjustment;
if the owner-occupant is employed by an employer, an employment verification requirement verifying the employment and gross income of the owner-occupant;
if the owner-occupant is self-employed, a three year balance sheet requirement verifying the ability of the owner-occupant to produce a sustained income;
a job security requirement verifying that an acceptable degree of job security applies to at least one of an occupation and an industry of employment of the owner-occupant;
a job security requirement verifying that an acceptable published job security score applies to at least one of an occupation and an industry of employment of the owner-occupant;
a requirement that applicable lease payments for the property will not exceed a specified percentage of the owner-occupant's gross income;
a requirement that a total of applicable lease payments and other recurring payment commitments of the owner-occupant will not exceed a specified percentage of the owner-occupant's gross income;
a requirement that there are no unsatisfied court judgments applicable to the owner-occupant;
a requirement that there are no pending civil or criminal court proceedings applicable to the owner-occupant; and
a requirement that there have been no prior un-discharged bankruptcies applicable to the owner-occupant during seven years prior to a proposed date of purchase.

3. The method of claim 1, wherein the occupant qualifying criteria applied to each owner-occupant include a requirement that applicable lease payments for the property will not exceed 25% of the owner-occupant's gross income.

4. The method of claim 1, wherein the occupant qualifying criteria applied to each owner-occupant include a requirement that a total of applicable lease payments and other recurring payment commitments of the owner-occupant will not exceed 34% of the owner-occupant's gross income.

5. The method of claim 1, wherein re-selling the plurality of purchased properties includes, for each purchased property, before accepting an offer from a third party to purchase the property, providing an opportunity to the qualified occupant to match the offer and thereby purchase the property.

6. The method of claim 1, wherein re-selling the plurality of purchased properties includes, for each purchased property, not reselling the purchased property for a specified period of time to any buyer other than the qualified occupant.

7. The method of claim 6, wherein the specified period of time is at least five years.

8. The method of claim 1, wherein re-selling the plurality of purchased properties includes offering to re-sell each purchased property to its qualified occupant at a resale price that is not higher than an appraised price, the appraised price being determined by at least one independent appraiser.

9. The method of claim 8, wherein the resale price is calculated by applying a repurchase discount percentage reduction to the appraised price, the repurchase discount percentage reduction being calculated on a basis which causes it to increase with time subject to sustained desirable behavior by the qualified occupant.
